(19) United States
(12) Patent Application Publication
(10) Pub. No.: US 2017/0168260 A1
(43) Pub. Date: Jun. 15, 2017

(54) LENS BARREL, OPTICAL DEVICE, AND IMAGING APPARATUS

(71) Applicant: CANON KABUSHIKI KAISHA, Tokyo (JP)

(72) Inventor: Toru Ishimasa, Kawasaki-shi (JP)

(21) Appl. No.: 15/373,596

(22) Filed: Dec. 9, 2016

(30) Foreign Application Priority Data
Dec. 11, 2015 (JP) 2015-242402

(51) Int. Cl. G02B 7/10; G02B 13/00

(52) U.S. Cl. CPC G02B 7/102; G02B 13/001

(57) ABSTRACT

A lens barrel having a photographing state and a collapsed state is provided. The lens barrel is provided with a fifth group lens unit which is retracted from a portion on an optical axis and a fourth group lens unit which is adjacent to the fifth group lens unit in a collapsed state. The fifth group lens unit is formed with a first cutout section and a second cutout section. A fourth group lens included in the fourth group lens unit is disposed in the second cutout section in the collapsed state.

### BACKGROUND OF THE INVENTION

### Field of the Invention

The present invention relates to a lens barrel, an optical device, and an imaging apparatus.

### Description of the Related Art

In recent years, higher magnification and miniaturization for an imaging apparatus such as a camera, a video camera, or the like are attempted. Therefore, in a lens barrel included in the imaging apparatus, some of lens groups in the lens barrel are retracted from a portion on an optical axis in a collapsed state when not photographing. In a photographing state, the lens barrel is fed out from a camera housing such that a distance between the lens groups is a distance which is required for photographing. Japanese Patent Laid-Open No. 2012-42649 discloses a lens barrel in which a collapsed length is shortened in a case where the lens barrel is stored by retracting a retractable lens if the transition from a photographing state to a collapsed state is performed.

In the lens barrel disclosed in Japanese Patent Laid-Open No. 2012-42649, since the retractable lens is retracted to an outside of an outermost diameter of the lens barrel, a size of the lens barrel is increased. Also, since there is a need to provide a hole used to retract the retractable lens to a lateral surface of the lens barrel in the lens barrel, reliability in strength and environmental resistance is reduced.

### SUMMARY OF THE INVENTION

The present invention provides a lens barrel in which a collapsed length can be shortened without increasing a lens barrel diameter.

A lens barrel according to an embodiment of the present invention has a photographing state and a collapsed state. The lens barrel comprises a retractable lens group which is retracted from a portion on an optical axis in the collapsed state and a first lens group which is adjacent to the retractable lens group. The retractable lens group is formed with a first cutout section and a second cutout section, and a lens included in the first lens group is disposed in the second cutout section in the collapsed state.

A lens barrel of the present invention can shorten a collapsed length without increasing a lens barrel diameter.

Further features of the present invention will become apparent from the following description of exemplary embodiments (with reference to the attached drawings).

### BRIEF DESCRIPTION OF THE DRAWINGS

FIG. 1 is a perspective view of an optical device of the present embodiment.

FIG. 2 is a perspective view of a lens barrel which is mounted in a digital camera.

FIG. 3 is an exploded perspective view of the lens barrel.

FIG. 4 is a cross-sectional view of the lens barrel at a collapsed position.

FIG. 5 is a cross-sectional view of the lens barrel at a photographing position.

FIG. 6 is a view illustrating a configuration of a fifth group unit.

FIGS. 7A to 7D are views for describing movement in a case where a retractable lens group and a first rectilinear cylinder transit from a photographing state to a collapsed state.

FIGS. 8A to 8D are views for describing movement in a case where the retractable lens group and the first rectilinear cylinder transit from the photographing state to the collapsed state.

FIGS. 9A to 9B are views illustrating states of a third group unit, a fourth group unit, and a fifth group unit in the photographing state.

FIGS. 10A to 10B are views illustrating states of the third group unit, the fourth group unit, and the fifth group unit in the collapsed state.

FIG. 11 is a view for describing a relationship of a retractable lens group and a lens group near the retractable lens group in the collapsed state.

### DESCRIPTION OF THE EMBODIMENTS

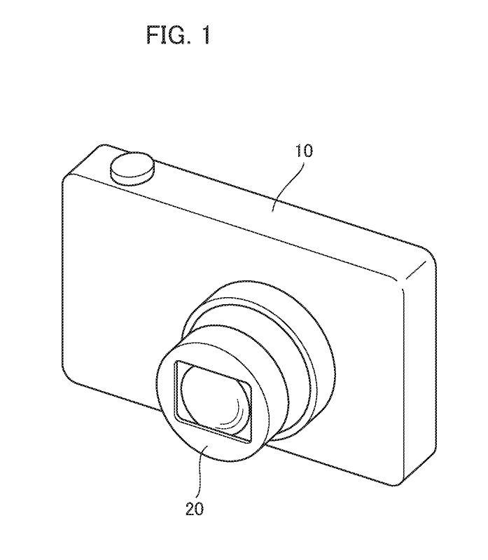

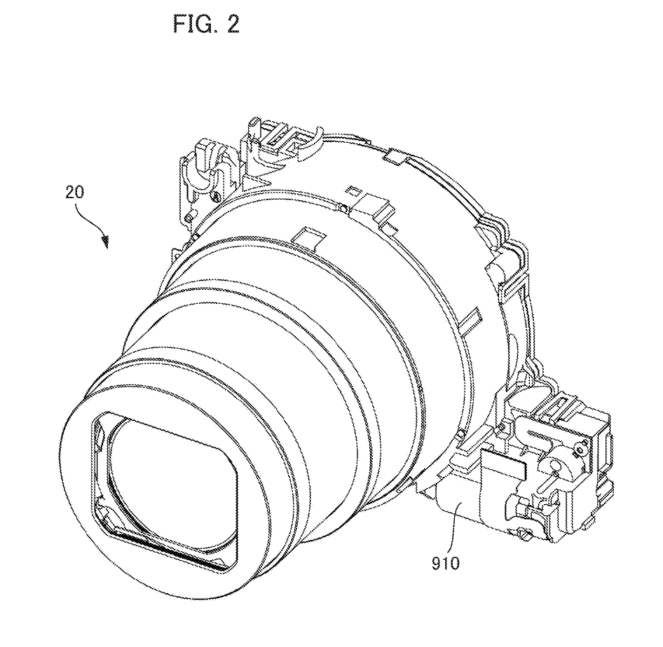

FIG. 1 is a perspective view of an optical device of the present embodiment. The optical device shown in FIG. 1 is a digital camera as an example of an imaging apparatus. FIG. 2 is a perspective view of a lens barrel which is mounted in the digital camera shown in FIG. 1.

As shown in FIGS. 1 and 2, the digital camera comprises a zoom type lens barrel 20 on a front side of a camera main body 10. The lens barrel 20 has a photographing state that is a state when photographing and a collapsed state that is a state in which the lens barrel 20 has a shorter total length than that in the photographing state, when not photographing. A photographing optical system included in the lens barrel 20 is driven by a zoom driving unit 910 and is moved between a photographing position corresponding to the photographing state and a collapsed position corresponding to the collapsed state in an optical axis direction to change a photographing magnification.

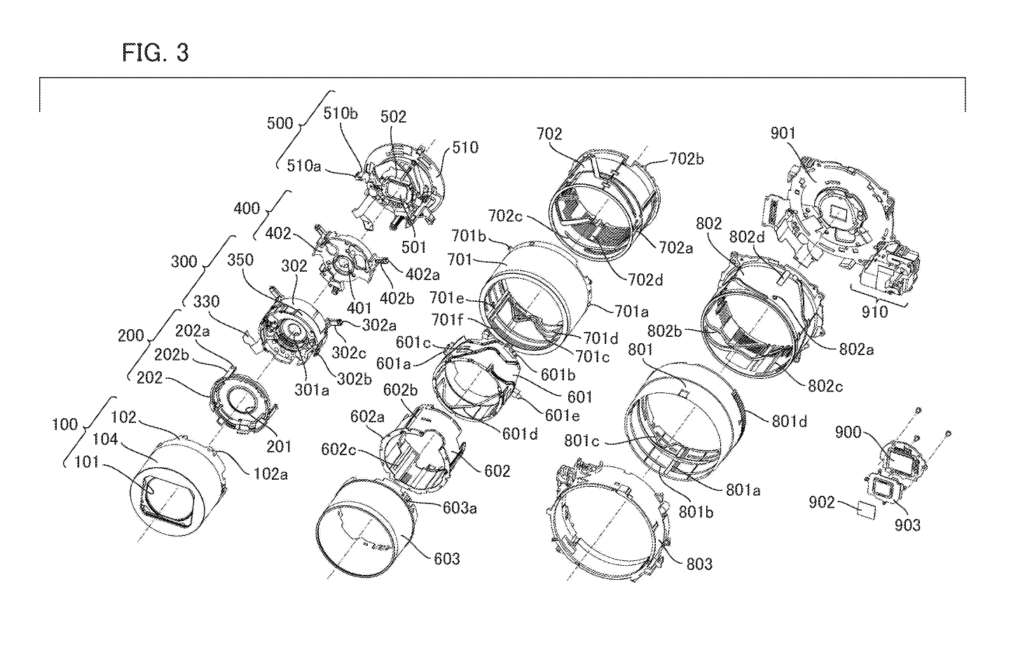

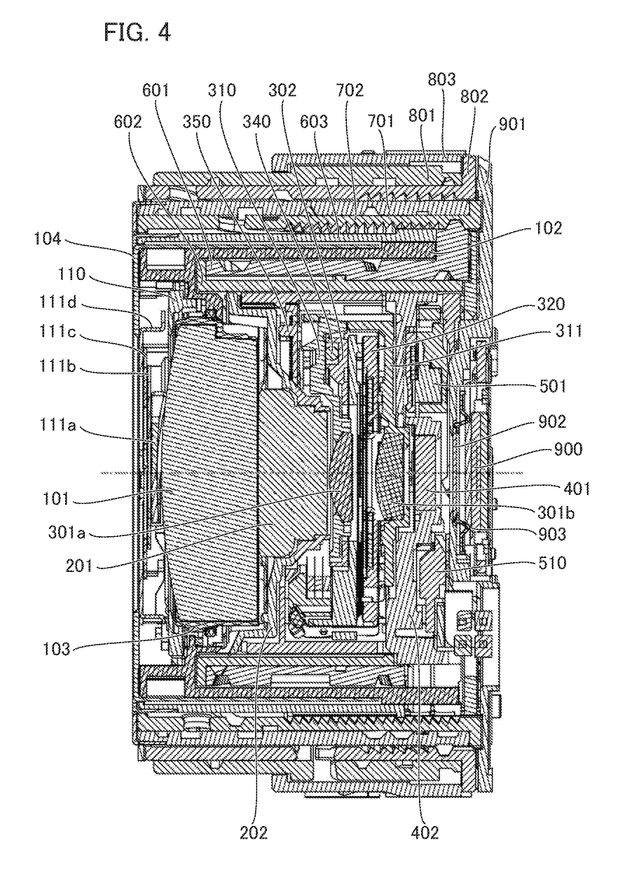

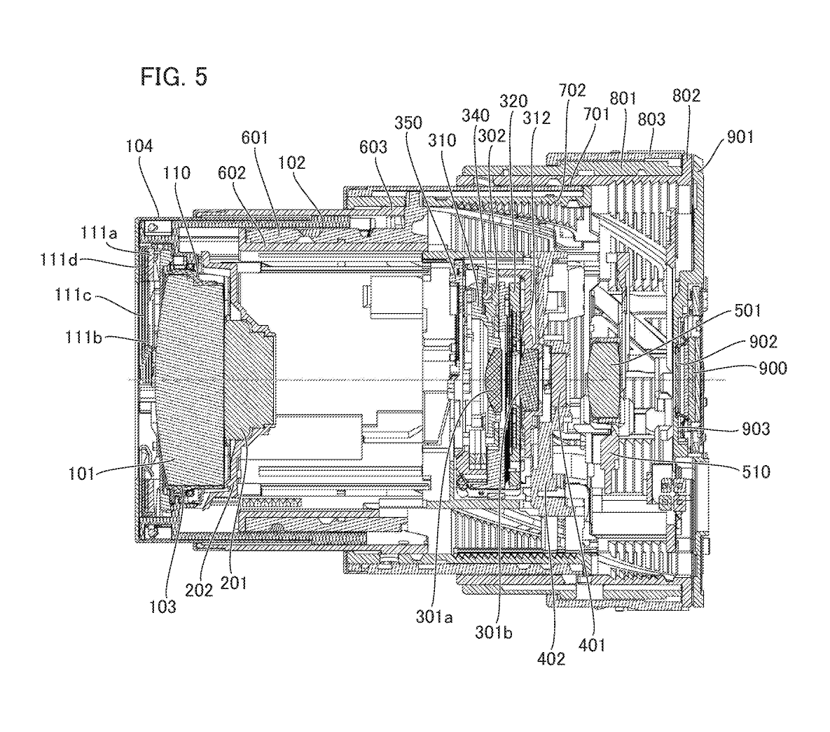

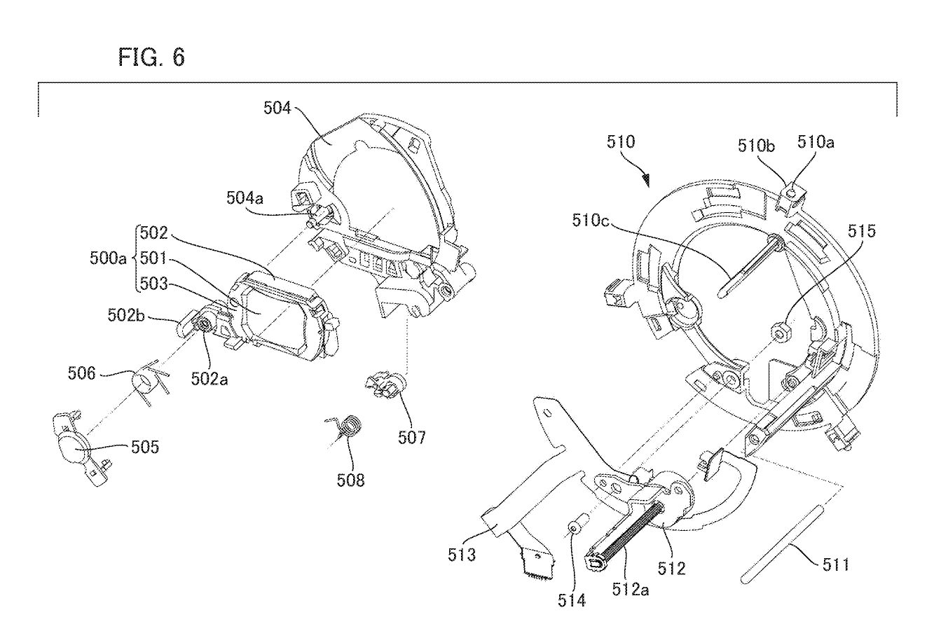

FIG. 3 is an exploded perspective view of the lens barrel. FIG. 4 is a cross-sectional view of the lens barrel at the collapsed position. FIG. 5 is a cross-sectional view of the lens barrel at the photographing position. FIG. 6 is a view illustrating a configuration of a fifth group unit.

The photographing optical system of the lens barrel 20 comprises a first group unit 100 having a first group lens 101, a second group unit 200 having a second group lens 201, and a third group unit 300 having third group lenses 301a and 301b. Note that, in the following description, the third group lenses 301a and 301b are also simply referred to as a third group lens 301. Also, the photographing optical system comprises a fourth group unit 400 having a fourth group lens 401 and a fifth group unit 500 having a fifth group lens 501.

An inner cam cylinder 601 is provided with a cam groove 601d in which a first rectilinear cylinder 602 is rotatably supported on an inner circumferential portion thereof through bayonet coupling and into which a follower 202a of a second group lens frame 202 is fitted. An outer circumferential portion of the inner cam cylinder 601 is provided with a follower 601a which is fitted into a cam groove 702c of a second rectilinear cylinder 702, an engagement part 601b which is engaged with an engagement part 603a of an inner cam cover 603, and a rectilinear key 601e which is fitted into a rectilinear groove 701e of an outer cam cylinder 701. Also, the inner cam cylinder 601 is provided with a cam groove 601c into which a follower 102a of a first group barrel 102 is fitted. An outer circumferential portion of the inner cam cover 603 is provided with the engagement part 603a which is engaged with the engagement part 601b of the inner cam cylinder 601, and the inner cam cover 603 and the inner cam cylinder 601 are assembled.

An outer circumferential portion of the first rectilinear cylinder 602 is provided with a rectilinear key 602a which is fitted into a rectilinear groove (not shown) provided inside the first group barrel 102. An inner circumferential portion of the first rectilinear cylinder 602 is provided with a rectilinear groove 602b into which a rectilinear key 202b of the second group lens frame 202 is fitted and a rectilinear groove 602c for a rectilinear key 302b of a third group base 302.

An inner circumferential portion of the outer cam cylinder 701 is provided with a cam groove 701f into which a follower 702a of the second rectilinear cylinder 702 is fitted. An outer circumferential portion of the outer cam cylinder 701 is provided with a follower 701a which is fitted into a cam groove 802b of a fixed cylinder 802 and a rectilinear key 701b which is fitted into a rectilinear groove 801a of a rotary cylinder 801. Also, an inner circumferential portion of the outer cam cylinder 701 is provided with a cam groove 701c into which a follower 302a of the third group base 302 is fitted, a cam groove 701d into which a follower 402a of a fourth group lens frame 402 is fitted, and the rectilinear groove 701e into which the rectilinear key 601e of the inner cam cylinder 601 is fitted.

An outer circumferential portion of the second rectilinear cylinder 702 is provided with a rectilinear key 702b into which a rectilinear groove 802c of the fixed cylinder 802 is fitted, and the follower 702a into which a cam groove 701f of the outer cam cylinder 701 is fitted. Also, an inner circumferential portion of the second rectilinear cylinder 702 is provided with a rectilinear groove 702d into which a rectilinear key 402b of the fourth group lens frame 402 is fitted and the cam groove 702c into which the follower 601a of the inner cam cylinder 601 is fitted.

An outer circumferential portion of the fixed cylinder 802 is provided with a follower 802a which is fitted into a cam groove 801b of the rotary cylinder 801. Also, an inner circumferential portion of the fixed cylinder 802 is provided with a rectilinear groove 802d into which a rectilinear key 510b of a fifth group base 510 is fitted, the rectilinear groove 802c into which the rectilinear key 702b of the second rectilinear cylinder 702 is fitted, and the cam groove 802b into which the follower 701a of the outer cam cylinder 701 is fitted.

An outer circumferential portion of the rotary cylinder 801 is provided with a gear part 801d which is connected to the zoom driving unit 910. Also, an inner circumferential portion of the rotary cylinder 801 is provided with the cam groove 801b into which the follower 802a of the fixed cylinder 802 is fitted, the rectilinear groove 801a into which the rectilinear key 701b of the outer cam cylinder 701 is fitted, and a cam groove 801c into which a follower 510a of the fifth group base 510 is fitted. A cover cylinder 803 is disposed outside the rotary cylinder 801, and the cover cylinder 803 is fixed to a sensor holder 901 in a form in which the rotary cylinder 801 and the fixed cylinder 802 are disposed between thereof.

The first group unit 100 has a barrier mechanism. The barrier mechanism comprises a first group lens frame 103 which holds the first group lens 101, the first group barrel 102, a barrier driving ring 110, a plurality of barrier blades 111a, 111b, 111c, and 111d, a barrier spring (not shown), and a first group cap 104. An inner circumferential portion of the first group barrel 102 is provided with a rectilinear groove (not shown) into which the rectilinear key 602a of the first rectilinear cylinder 602 is fitted and the follower 102a into which the cam groove 601c of the inner cam cylinder 601 is fitted.

The second group unit 200 has the second group lens 201 and the second group lens frame 202. The second group unit 200 is provided with the follower 202a which is fitted into the cam groove 601d of the inner cam cylinder 601 and the rectilinear key 202b which is fitted into the rectilinear groove 602b of a first rectilinear cylinder 602.

The third group unit 300 serves as a second lens group which are adjacent to the fourth group unit 400. The third group unit 300 has a camera shake correction mechanism and a shutter/aperture unit 320. The camera shake correction mechanism is a mechanism which suppresses blurring of an image (image blur) due to camera shake. The third group base 302 is provided with the rectilinear key 302b which is fitted into the rectilinear groove 602c of the first rectilinear cylinder 602 and the follower 302a which is fitted into the cam groove 701e of the outer cam cylinder 701.

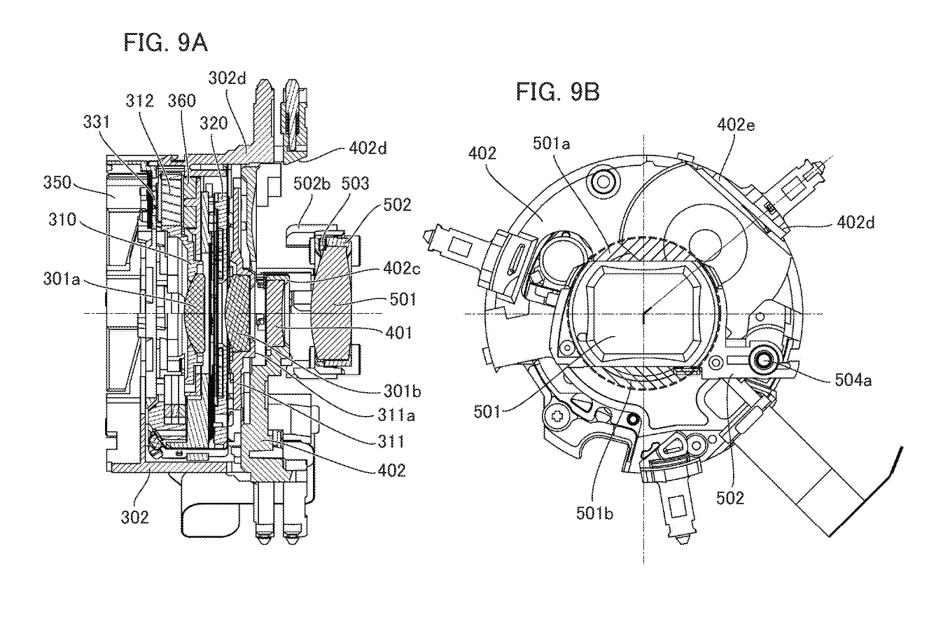

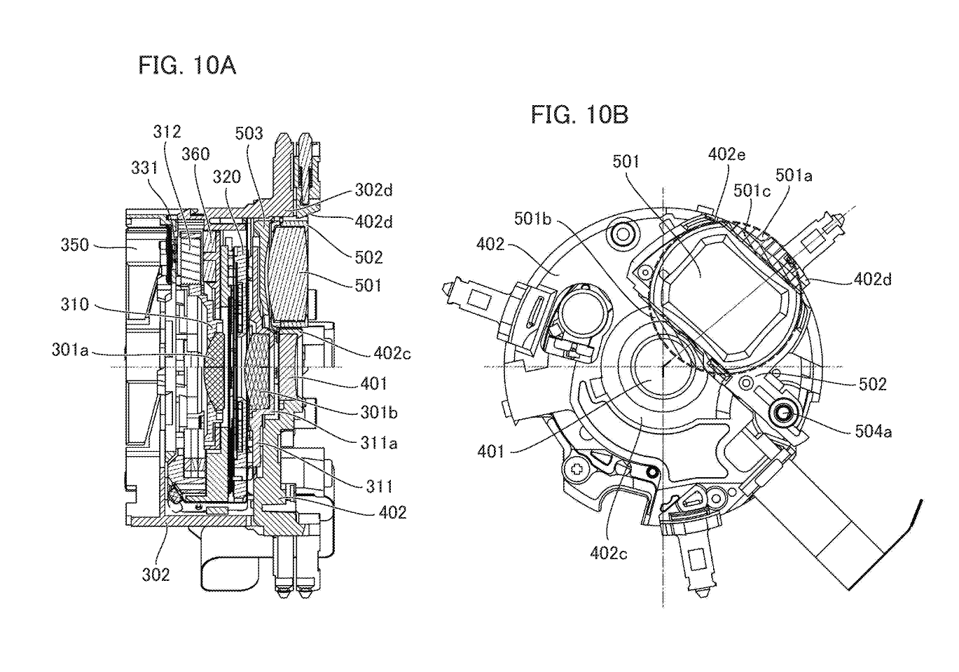

Third group lens frames 310 and 311 are disposed in a form in which surround the shutter/aperture unit 320 is disposed between thereof. Also, a pair of IS magnets 312 held by the third group lenses 301a and 301b and the third group lens frame 310 (FIGS. 9A to 10B).

A pair of IS coils 360 are fixed to a position of the third group base 302, which faces the IS magnets 312 (FIGS. 9A to 10B). The third group base 302 is a base member which movably holds the third group lens frame 310 within a plane which is perpendicular to the optical axis via a plurality of IS balls 340 due to tension of an IS spring (not shown). A pair of Hall elements 331 which are held by a flexible printed circuit (FPC) 330 is held by an IS sensor holder 350 at a position of a subject side of the IS magnets 312, which faces the IS magnets 312 (FIGS. 9A to 10B).

In the third group lens frames 310 and 311, power is applied to the IS coils 360 via the FPC 330. A Lorentz force acts between the IS coils 360 and the IS magnets 312, the third group lens frames 310 and 311 are moved within the plane which is perpendicular to the optical axis, and positions thereof are controlled by the Hall elements 331. Thus, the image blurring due to camera shake is suppressed.

The fourth group unit 400 serves as a first lens group which is adjacent to the fifth group unit 500, a retractable lens group 500a. (FIG. 6) in the fifth group unit 500 and the third group unit 300. The fourth group unit. 400 has the fourth group lens 401 and the fourth group lens frame 402 which holds the fourth group lens 401. The fourth group lens frame 402 is provided with the follower 402a which is fitted into the cam groove 701d of the outer cam cylinder 701 and the rectilinear key 402b which is fitted into the rectilinear groove 702d of the second rectilinear cylinder 702.

The fifth group unit 500 shown in FIGS. 3 and 6 serves as a focus lens group having a focus mechanism. The focus mechanism has the fifth group lens 501, a fifth group lens frame 502, a fifth group cover 503, an AF base 504, an AF cover 505, an AF spring 506, a rack 507, a rack spring 508, the fifth group base 510, and a main guide shaft 511. Also, the focus mechanism has a focus motor 512, an FPC 513, a screw 514, and a nut 515.

The retractable lens group 500a is configured such that the fifth group lens 501 is held by the fifth group lens frame 502 and the fifth group cover 503. The fifth group lens frame 502 comprises a corner 502b and a follower 502a. The AF base 504 holds the rack 507 and the rack spring 508. Also, the AF base 504 has a rotary shaft 504a. The AF base 504 rotatably holds the fifth group lens frame 502 in a direction of the plane which is perpendicular to the optical axis as the rotary shaft 504a is engaged with the follower 502a. The AF cover 505 and the AF base 504 are assembled in a form in which the fifth group lens frame 502 is biased via the AF spring 506 in the optical axis direction.

The main guide shaft 511 is press-fitted into the fifth group base 510 and the focus motor 512, to which the FPC 513 is connected, is fixed to the fifth group base 510 using the screw 514 and the nut 515. Also, the fifth group base 510 has the follower 510a which is fitted into the cam groove 801c of the rotary cylinder 801 and the rectilinear key 510b which is fitted into the rectilinear groove 802d of the fixed cylinder 802.

Rotation of the AF base 504 is regulated by the main guide shaft 511 and a sub-guide 510c which is provided at the fifth group base 510. If the focus motor 512 is driven, the AF base 504 is advanced or retracted toward any position in the optical axis direction using feeding of a screw 512a and the rack 507, and focus can thus be adjusted. The sensor holder 901 holds the zoom driving unit 910 and holds an optical element 902, a sensor rubber 903, and an imaging element 900.

Zoom driving of the lens barrel 20 will be described. If the rotary cylinder 801 is rotationally driven by the zoom driving unit 910, the outer cam cylinder 701 is moved in the optical axis direction while rotating by an action of the rotary cylinder 801 and the fixed cylinder 802. The inner cam cylinder 601 is rotatably held by the first rectilinear cylinder 602, and the outer cam cylinder 701 is rotatably held by the second rectilinear cylinder 702. If the outer cam cylinder 701 is rotationally driven through the rotary cylinder 801, the inner cam cylinder 601 is rotationally driven through the outer cam cylinder 701. Also, the rotation of the first rectilinear cylinder 602 and the second rectilinear cylinder 702 is regulated by the fixed cylinder 802 via the third group base 302 so that the outer cam cylinder 701 and the inner cam cylinder 601 are moved in the optical axis direction while rotating.

The rotation of the first group unit 100 and the second group unit 200 is regulated by the first rectilinear cylinder 602, and the first group unit 100 and the second group unit 200 are linearly moved in the optical axis direction by an action of the inner cam cylinder 601. The rotation of the third group unit 300 and the fourth group unit 400 is regulated by the second rectilinear cylinder 702, and the third group unit 300 and the fourth group unit 400 are linearly moved in the optical axis direction by an action of the outer cam cylinder 701. In the fifth group unit 500, the rotation of the fifth group base 510 is regulated by the fixed cylinder 802, and the fifth group base 510 is linearly moved in the optical axis direction by an action of the rotary cylinder 801.

The rotation of the AF base 504 is regulated by the main guide shaft 511 and the sub-guide 510c. Also, the AF base 504 is linearly moved in the optical axis direction by an action of a lead screw 512a which is integrally formed with an output shaft of the focus motor 512, and the rack 507, while being held by the fifth group base 510 regardless of an action of the rotary cylinder 801 or the fixed cylinder 802. Using the above-described actions, as the rotary cylinder 801 is rotationally driven by the zoom driving unit 910 in the lens barrel 20, the lens groups are fed out respectively. Then, the fifth group lens 501 is fed out toward any position as the focus motor 512 is driven via the FPC 513. Thus, the lens barrel 20 transits from the collapsed state to the photographing state.

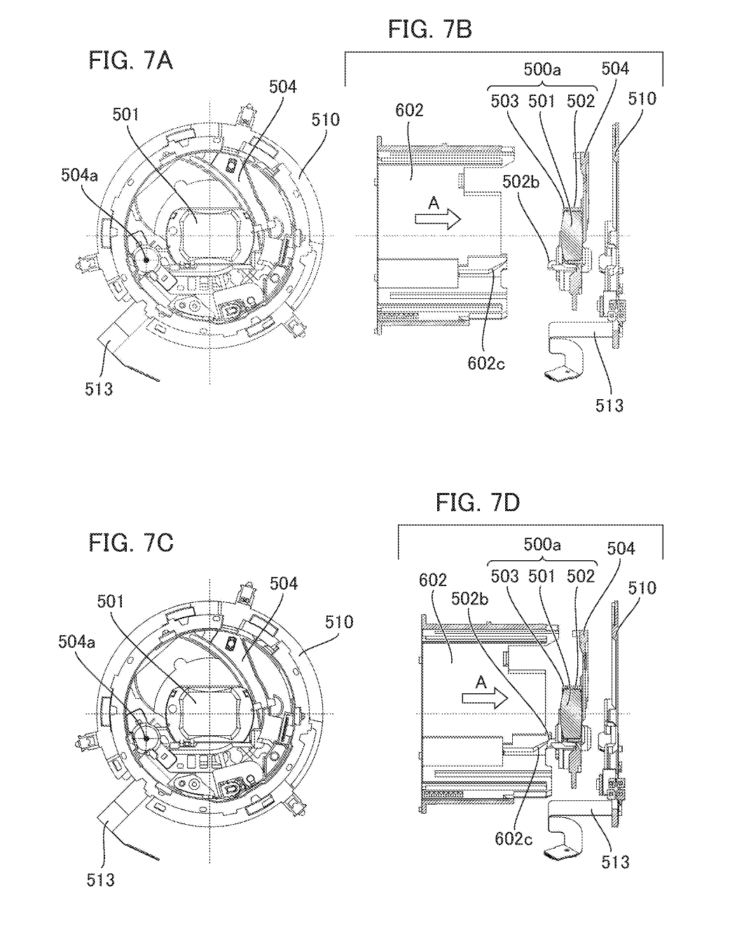

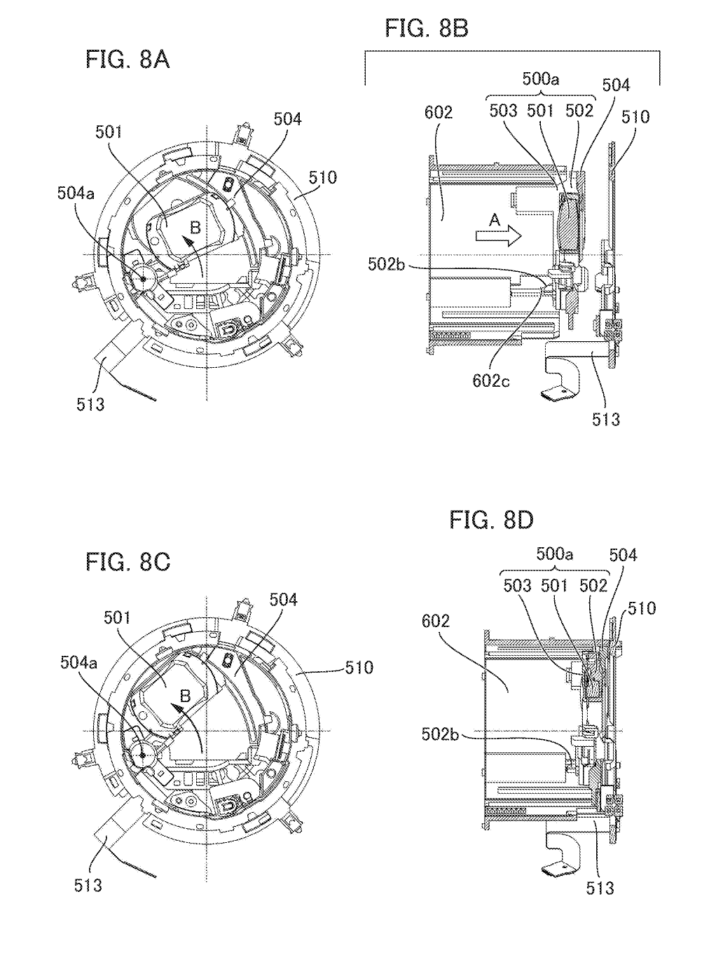

Next, a method of retracting the fifth group unit 500 will be described with reference to FIGS. 7A to 11. FIGS. 7A to 8D are views for describing movement in a case where the retractable lens group 500a and the first rectilinear cylinder 602 transits from the photographing state to the collapsed state. FIGS. 7A, 7C, 8A, and SC illustrate states when the retractable lens group 500a and the first rectilinear cylinder 602 are viewed from the front. FIGS. 7B, 7D, 8B, and 8D illustrate cross sections of the retractable lens group 500a and the first rectilinear cylinder 602. FIG. 7B corresponds to FIG. 7A. FIG. 7D corresponds to FIG. 7C. FIG. 8B corresponds to FIG. 8A. FIG. 8D corresponds to FIG. 8C.

FIGS. 9A and 9B are views illustrating states of the third group unit 300, the fourth group unit 400, and the fifth group unit 500 in the photographing state. FIG. 9B illustrates a state when the third group unit 300, the fourth group unit 400, and the fifth group unit 500 are viewed from the front. FIG. 9A illustrates cross sections of the third group unit 300, the fourth group unit 400, and the fifth group unit 500.

FIGS. 10A and 10B are views illustrating states of the third group unit 300, the fourth group unit 400, and the fifth group unit 500 in the collapsed state. FIG. 10B illustrates states when the third group unit 300, the fourth group unit 400, and the fifth group unit 500 are viewed from the front. FIG. 10A illustrates cross sections of the third group unit 300, the fourth group unit 400, and the fifth group unit 500.

If the lens barrel 20 transits from the photographing state to the collapsed state, the first rectilinear cylinder 602 starts to move from a state shown in FIGS. 7A and 7B in an arrow A direction by actions of cylinders, and a distance between the first rectilinear cylinder 602 and the fifth group unit 500 shortens.

The first rectilinear cylinder 602 is provided with a cam part 602c, and the fifth group lens frame 502 is provided with the corner 502b. As shown in FIGS. 7C and 7D, if the transition to the collapsed state is progressed, the cam part 602c comes into contact with the corner 502b.

Also, if the transition to the collapsed state is further progressed, as shown in FIGS. 8A and 8B, the retractable lens group 500a starts to be retracted while rotating in the direction (an arrow B direction) of the plane, which is perpendicular to the optical axis, about the rotary shaft 504a by actions of the cam part 602c and the corner 502b.

If the transition of the lens barrel 20 from the photographing state to the collapsed state is completed, the retracting of the retractable lens group 500a from a portion on the optical axis is completed by actions of the cam part 602c and a corner 502c, and as shown in FIGS. 8C and 8D, the retractable lens group 500a is disposed at a collapsed standby position.

Here, shapes of the fifth group lens 501 and the fifth group lens frame 502 are focused on. A first cutout section 501a and a second cutout section 501b are formed on an outer circumference of a region other than a usage region of the fifth group lens 501. Thus, the fifth group lens 501 has a non-circular shape. The fifth group lens frame 502 and the fifth group cover 503 also have non-circular shapes in forms in which the fifth group lens frame 502 and the fifth group cover 503 follow a shape of the fifth group lens 501 (FIGS. 9B and 10B).

It is assumed that the lens barrel 20 transits to the collapsed state and the retractable lens group 500a is retracted to the collapsed standby position. In this case, after the retractable lens group 500a is retracted, a portion 402c of the fourth group lens 401 and the fourth group lens frame 402 and a portion 311a of the third group lens 301 and a third group lens frame 311 are housed in a region (a space) which is formed by the second cutout section 501b.

A portion 402d of an outer circumferential portion of the fourth group lens frame 402 is housed in a space 501c serving as a region, which is on the inside of an outermost circumferential portion 402e of the fourth group lens frame 402, in the region which is formed by the first cutout section 501a. To be specific, the portion 402d of the outer circumferential portion of the fourth group lens frame 402 is a portion of the follower 402a of the fourth group lens frame 402. Simultaneously, a portion 302d of the third group base 302 is housed in the space 501c. To be specific, the portion 302d of the third group base 302 a portion of the follower 302a of the third group base 302. Thus, a degree of freedom of a layout of the followers 402a and 302a is improved.

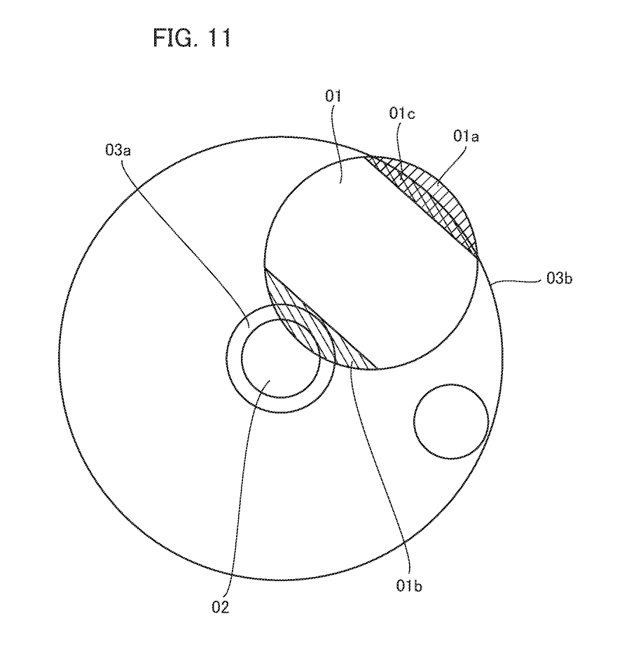

FIG. 11 is a view for describing a relationship of the retractable lens group and a lens group near the retractable lens group in the collapsed state. A retractable lens 01 in FIG. 11 corresponds to the fifth group lens 501 which is included in the retractable lens group 500a. A first cutout section 01a corresponds to the first cutout section 501a. A second cutout section 01b corresponds to the second cutout section 501b.

The retractable lens 01 has a non-circular shape in which an outer circumference of the region other than the usage region thereof is provided with the first cutout section 01a and the second cutout section 01b. A lens 02 of a first group unit and a portion 03a of the first group unit, which are adjacent to the second cutout section 01b, are disposed in a space which is formed by the second cutout section 01b in the collapsed state. Furthermore, a portion of an outer circumferential portion of the first group unit is disposed in a space 01c serving as a region, which is on the inside of an outermost circumferential portion 03b of the first group unit, in the region which is formed by the first cutout section 01a.

In the related art, since a retractable group is retracted and collapsed to a portion which is on an outside of an outermost diameter of a lens barrel if a focus group is retracted and a collapsed length is reduced, a size of the lens barrel is increased. Also, in the conventional lens barrel, a hole used to retract a lens is open in a lateral surface of the lens barrel so that reliability in strength and environmental resistance is reduced.

In the lens barrel of the present embodiment, an outer circumferential portion of the region other than the usage region of the fifth group lens 501 serving as the retractable group is provided with the first cutout section 501a and the second cutout section 501b. Also, after the retractable lens group 500a is retracted in the collapsed state, the portion 402c of the fourth group lens 401 and the fourth group lens frame 402 is disposed in the space which is formed by the second cutout section 501b. Furthermore, the portion 402d of the outer circumferential portion of the fourth group lens frame 402 is disposed in the space 501c serving as a region, which is on the inside than the outermost circumferential portion 402e of the fourth group unit 400, in the region which is formed by the first cutout section 501a.

Also, after the retractable lens group 500a is retracted, the portion 311a of the third group lens 301 and the third group lens frame 311 is disposed in the space which is formed by the second cutout section 501b. A portion 302d of the third group base 302 is disposed in the space 501c, which is on the inside of the outermost circumferential portion 402e of the fourth group unit 400, in the region which is formed by the first cutout section 501a. Therefore, the retractable lens group 500a can be housed in the lens barrel without retracting the retractable lens group 500a to a portion which is on the outside of an outermost diameter of the lens barrel 20, and compactness of the lens barrel 20 can be realized. Since there is no need to provide a bole for retracting in a lateral surface of the lens barrel 20, deterioration of the compactness of the lens barrel 20 and the reliability in strength and environmental resistance can be suppressed. Since the portion 402d of the outer circumferential portion of the fourth group lens frame 402 and the portion 302d of the third group base 302 can be disposed is the space 501c, the degree of freedom of the layout is improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-242402, filed Dec. 11, 2015 which is hereby incorporated by reference wherein in its entirety.

What is claimed is:

1. A lens barrel with a photographing state and a collapsed state, the lens barrel comprising:
a retractable lens group which is retracted from a portion on an optical axis in the collapsed state; and
a first lens group which is adjacent to the retractable lens group,
wherein the retractable lens group is formed with a first cutout section and a second cutout section, and
a lens included in the first lens group is disposed in the second cutout section in the collapsed state.

2. The lens barrel according to claim 1, wherein a portion of a lens frame which holds the lens included in the first lens group is disposed in the second cutout section in the collapsed state.

3. The lens barrel according to claim 1, wherein a portion of an outer circumferential portion of the first lens group is disposed in a region, which is on an inside than an outermost circumferential portion of the first lens group, in a region of the first cutout section in the collapsed state.

4. The lens barrel according to claim 1, wherein a portion of an outer circumferential portion of the lens frame which holds the lens included in the first lens group is disposed in a region, which is on an inside than an outermost circumferential portion of the first lens group, in a region of the first cutout section in the collapsed state.

5. The lens barrel according to claim 1, wherein the retractable lens croup is a focus lens group.

6. The lens barrel according to claim 1, wherein the first cutout section and the second cutout section are formed in an outer circumferential portion of a region other than a usage region of a lens included in the retractable lens group.

7. The lens barrel according to claim 1, further comprising:
a second lens group which is adjacent to the first lens group,
wherein a lens included in the second lens group is disposed is the second cutout section in the collapsed state.

8. The lens barrel according to claim 7, wherein a portion of a lens frame which holds the lens included in the second lens group is disposed in the second cutout section in the collapsed state.

9. The lens barrel according to claim 7, wherein a portion of a base member included in the second lens group is disposed in a region, which is on an inside of an outermost circumferential portion of the first lens group, in a region of the first cutout section in the collapsed state.

10. An optical device comprising:
the lens barrel according to claim 1.

11. An imaging apparatus comprising:
the lens barrel according to claim 1.
